(19) United States
(12) Patent Application Publication
(10) Pub. No.: US 2018/0235198 A1
(43) Pub. Date: Aug. 23, 2018

(54) FISHING LINE AND CONNECTOR (2)

(71) Applicant: Hency Anthony Bunner, Louisville, KY (US)

(72) Inventor: Hency Anthony Bunner, Louisville, KY (US)

(21) Appl. No.: 15/437,670

(22) Filed: Feb. 21, 2017

(51) Int. Cl. A01K 91/04; A01K 99/00; B25B 27/14

(52) U.S. Cl. CPC A01K 91/04; B25B 27/146; A01K 99/00

(57) ABSTRACT

The apparatus is an attachment device for connecting a fishing line to a fishing hook without tying a knot. The apparatus is cylindrical metal tube configuration. The body of the tube is crimped 90 degrees starting from the center of the tube to each end as to restrict the fishing hood, when inserted, from completely penetrating through the tube. The fishing line is first inserted completely through the tube. The fishing hook, eye end, is then inserted. Once both the fishing line and fishing hook are inserted, a crimping tool is applied to create and interference fit thus locking the fishing line and fishing hook inside the tube.

### PROVISIONAL PATENT APPLICATION

No. 62/498,277

File Date: Dec. 20, 2016

### RELEVANT PRIOR ART

### U.S. Patents

| Patent Number | Kind Code | Issue Date | Patentee |
|---|---|---|---|
| 9,433,198 | B2 | 2016 Sep. 6 | O'Neal |
| 9,301,514 | B2 | 2016 Apr. 5 | Pearcy |
| 9,185,891 | B2 | 2015 Nov. 17 | Nakamichi |
| 8,936,282 | Bl | 2015 Jan. 20 | Berdahl |
| 2010/0156100 | Al | 2010 Jun. 24 | Goldsmith |
| 2004/0216360 | Al | 2004 Nov. 4 | Holtzhampf |
| 5,638,633 | Al | 1997 Jun. 17 | Hoffman Jr. |

The present invention relates to a soft-metal device that will allow a fisherman to secure a hook to a fishing line without the necessity of tying a knot.

Specifically, the present invention relates to an aerodynamic configuration that locks the fishing line to the fishing hook within the apparatus simply and securely every single time.

### BACKGROUND INFORMATION

Millions of people enjoy the sport of fishing. However, the tying and knotting of a fish hook to the end of a fishing line is a tedious and time-consuming task. Most fish hooks are provided with an eye, through which the end of the fishing line must be threaded. When the line is threaded, the tail end of the line is formed into a loop and the hook is manually twisted so that several twists of the line are imparted to the loop. The tail end of the line is then threaded through the loop after which the loop is tightened to form a knot around the fish hook eye so that the hook is firmly secured to the end of the line.

The present invention provides a portable apparatus which greatly simplifies the task of securing a fish hook to a fishing line and does so in a manner that is much quicker and simpler than the process of tying a conventional knot.

The apparatus is preferably fabricated from a round hollow soft metal tube that is crimped flat 90 degrees at an equal distance from each end starting from the middle of the apparatus. The apparatus is crimped flat just enough to allow the fishing hook and line to freely enter the apparatus.

The proper operation of securing the fishing line to the hook requires threading the fishing line completely through a channel within the apparatus, then through the eye of the fishing hook (which is placed in the apparatus), and back through the apparatus.

The invention is designed to secure the fishing line and fishing hook within the apparatus. Once the fishing line has twice entered the apparatus (above), the eye end of the fishing hook is inserted into the apparatus opposite the end the fishing line was originally entered. Once the fishing line and fishing hook are inserted into the apparatus, the apparatus is then crimped (squeezed) to create an interference fit between the fishing line, fishing hook and the apparatus simultaneously. An accompanying customized crimping device is specifically designed for use in conjunction with the apparatus to insure a correct crimp and to avoid fracturing the line, which standard pliers may cause.

The apparatus is specifically configured to work in conjunction with all types of lures, crankbaits and spinnerbaits. It will also work with any kind of fishing line: monofilament, braided, fluorocarbon or wire. It is calibrated for use with all types of conventional fishing hooks

Therefore, the primary feature of the present invention is the provision of an apparatus that greatly simplifies the task of securing a fish hook to a line by eliminating the necessity of tying a knot.

Another feature of the apparatus is that it overcomes the problems associated with the prior art devices which can cause damage to or slippage of the line and takes unnecessary time and effort.

Other features and advantages of the present invention will be clear to those skilled in the art by a consideration of the detailed description of a preferred embodiment of the present invention contained herein.

### SUMMARY

The present invention relates to an apparatus for connecting a fish hook to a line without the necessity of tying a knot. The apparatus includes a soft, metal tube crimped 90 degrees from the center out both ends. The fishing line or fishing hook can enter initially from either end due to the apparatus being cemeterial in design.

Additionally, the body of the apparatus is designed so as to allow the fishing hook to only be inserted half way through the device. Once the fishing hook enters the apparatus, the fishing hook is restricted at the center of apparatus due to the 90 degrees bend in the apparatus. This allows the fishing hook to be held securely in place while the interference fit is made.

The fishing line must enter the apparatus at both ends to be effectively secured within the apparatus so as not to exceed the tensile strength of the fishing line.

The apparatus is specifically designed to be light-weight so as to not interfere with the action of the bait. It's perfectly sized and balanced aerodynamic design allows the bait to “swim” true with natural movement, while giving the fisherman complete control and finesse of the desired action.

The apparatus is also designed to allow, if desired, the fishing hook to remain outside of the apparatus. In this configuration, the fishing line is first strung through the apparatus, then though the eye of the fish hook and back through the apparatus; leaving the fishing hook outside the apparatus. The apparatus is then crimped, creating an interference fit between just the fishing line and the apparatus.

Furthermore, the apparatus is constructed of soft metal in assorted sizes (from ½ inch to 6 inch in length and ¼ inch to 2 inch in diameter) to accommodate the full range of fishing lines and fish hook sizes for both saltwater and freshwater fishing.

Depending on the size of the hook, the length of the apparatus changes in accordance with the amount of interference fit required to firmly lock the fishing line and hook in place within the apparatus.

Furthermore, the accompanying flat-edged crimping tool was specifically created in such a manner to provide an angled, uniform crimp across the apparatus when the crimp is applied. A standard pillar contained in most pliers has a sharp edge which would facture the line when the crimp is applied. The flat surface of the customized crimping tool applies a uniform force across the entire apparatus simultaneously which presses the apparatus over a larger surface of the line. Also, a standard pillar without having an angled surface will crimp the apparatus on one side and not the other when the crimp is applied. The angled surface establishes an equal force across the entire surface and not just on one side. Without the flat/angled surface of the customized crimping tool, the crimp would fracture the line and/or allow room for the line to slip through and separate from the apparatus.

### DRAWINGS FIGURES

FIG. 1A & FIG. 1B. This diagram show the apparatus (1) prior to being connected to the fish hook and the fishing line. The apparatus (1) is made of lightweight cylinder (tube) soft material (example: copper or aluminum). The cylinder is formed at both ends into an oval shape (4) at 90 degrees (5) equally from both ends. The symmetrical design will allow the fish hook (2) or the fish line (3) to be inserted into either end. The oval shape formed at 90 degrees (5) from both ends restricts the fish hook, allowing it to only penetrate half way into the apparatus.

FIG. 2A. The fishing line (3) entered the apparatus (1) from one end completely through the apparatus. When the fishing line (3) exits the apparatus, the fishing line (3) is threaded through the eye of the fish hook (2) and back though the apparatus (1).

FIG. 2B. Once the fishing line is threaded through the apparatus (1), through the eye of the fish hook and back though the apparatus (1), the fishing line is pulled back tight through the apparatus, eliminating any excess line and (1) until is it wedged tight against the 90-degree (5) bend in the apparatus. The fish hook and the fishing line are now ready to be locked in place.

FIG. 3A. The diagram shows a cutting away view of the apparatus (1) with the eye of the fish hook (2) and the fishing line (3) in place within the apparatus prior to being crimped by the accompanying crimping tool FIG. 7 (6).

FIG. 3B. The diagram shows a cutting away view of the apparatus (1) once the crimping tool FIG. 7 (6) has been applied. The apparatus was designed to eliminate the time and necessity of tying a knot in the fishing line to secure the hook. The major problem with other existing devices is they allow the fishing line to slip off. Once the fish hook (2) and the fishing line is (3) are in place, the crimping tool FIG. 7 (6) is used to create an interference fit by crimping both ends of the apparatus. It is important that the fishing line (3) be threaded through the apparatus (1) twice to ensure there is a no-slip fit.

FIG. 4A. A special accompanying crimping tool (6) is designed to insure a uniform crimp across the entire oval (4) of the apparatus (1). The “V” shape of standard commercial pillars (pliers) would only crimp one side of the apparatus allowing the fishing line (2) room to fracture or slip. The specially designed crimping tool (1) is designed to have a tight fit at the top and a 1/16″ opening at the bottom (8).

FIG. 4B. The accompanying crimping tool (6) is shown once the apparatus (1) is crimped with a uniform crimp across the top (7) of the apparatus to the bottom (8) of the apparatus.

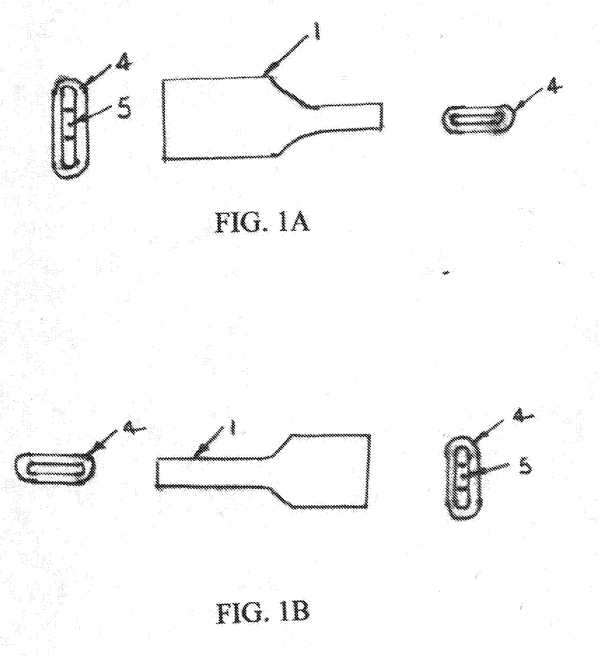

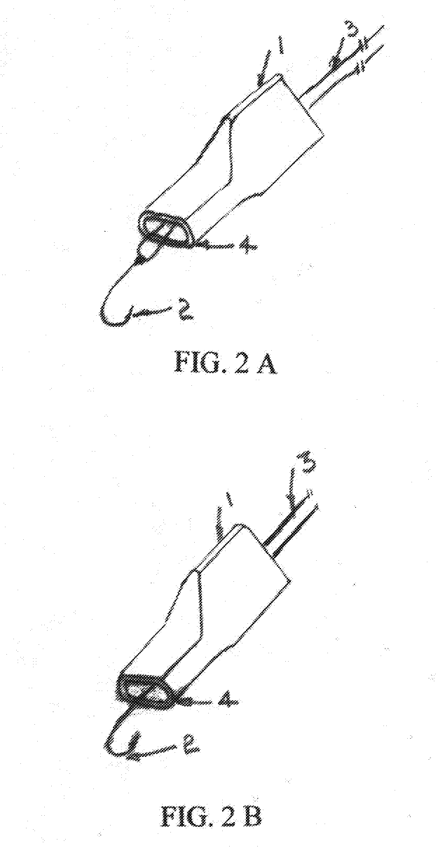

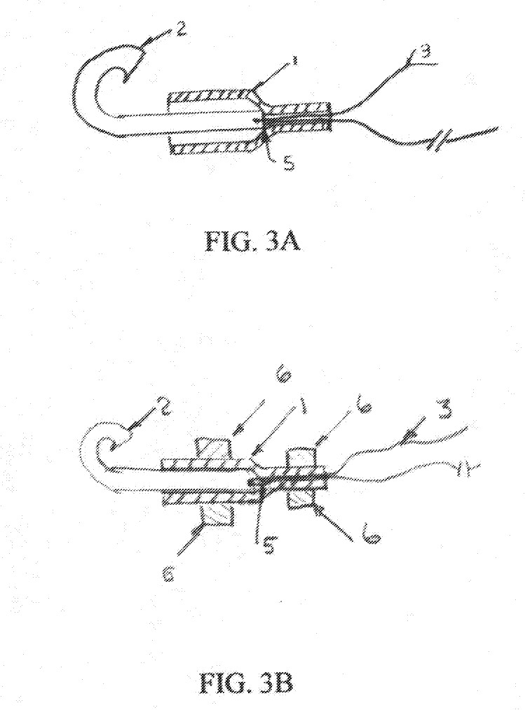

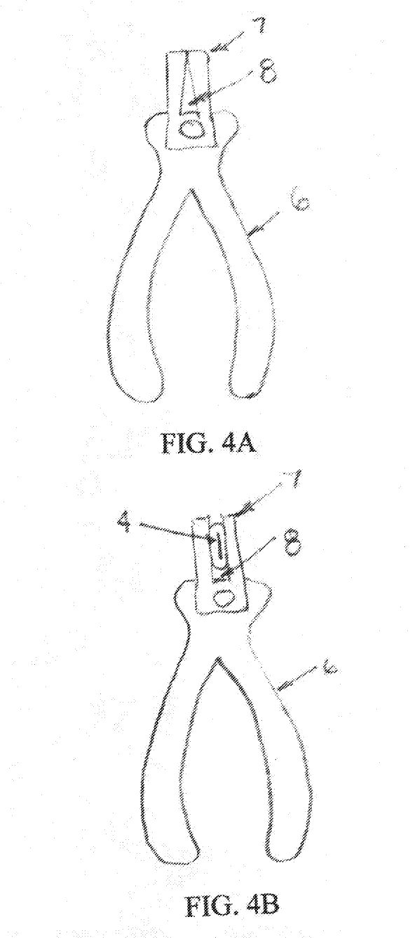

1. Millions of people enjoy the sport of fishing. However, the tying and knotting of a fish hook to the end of a fishing line is a tedious and time-consuming task. Most fish hooks are provided with an eye, through which the end of the fishing line must be threaded. When the line is threaded, the tail end of the line is formed into a loop and the hook is manually twisted so that several twists of the line are imparted to the loop. The tail end of the line is then threaded through the loop after which the loop is tightened to form a knot around the fish hook eye so that the hook is firmly secured to the end of the line.

2. (canceled)

3. The apparatus is fabricated from a round hollow soft metal tube that is crimped flat 90 degrees at an equal distance from each end starting from the middle of the apparatus. The apparatus is crimped flat just enough to allow the fishing hook and line to freely enter the apparatus from either end. The proper operation of securing the fishing line to the hook requires threading the fishing line completely through a channel within the apparatus, then through the eye of the fishing hook (which is placed in the apparatus), and back through the apparatus.

4. (canceled)

5. Once the fishing line and fishing hook are inserted into the apparatus, the apparatus is then crimped (squeezed) to create an interference fit between the fishing line, fishing hook and the apparatus simultaneously. An accompanying customized crimping device is specifically designed for use in conjunction with the apparatus to insure a correct crimp and avoid fracturing the line. The apparatus is specifically configured to work in conjunction with all types of lures, crankbaits and spinnerbaits. It will also work with any kind of fishing line: monofilament, braided, fluorocarbon or wire. It is calibrated for use with all types of conventional fishing hooks.

6. (canceled)

7. (canceled)
